(19) United States
(12) Patent Application Publication
(10) Pub. No.: US 2014/0149263 A1
(43) Pub. Date: May 29, 2014

(54) Data Assembly, Transfer and Storage

(71) Applicant: Mashinery Pty Ltd., Toorak VIC (AU)

(72) Inventors: Matthew Charles Denton, Bronte (AU); Henry William Peter Beadle, Chipping Norton (AU); Joseph Alan Narai, Alexandria (AU); Simon Peter Narai, Alexandria (AU); James Ian Murchison, Ashfield (AU)

(73) Assignee: Mashinery Pty Ltd., Toorak VIC (AU)

(21) Appl. No.: 14/092,573

(22) Filed: Nov. 27, 2013

Related U.S. Application Data
(60) Provisional application No. 61/730,093, filed on Nov. 27, 2012.

(51) Int. Cl. G06F 17/24; G06Q 30/06

(52) U.S. Cl. CPC G06F 17/243; G06Q 30/0641
USPC 705/27.1; 715/224; 715/226

(57) ABSTRACT

A user registers with a server system and provides user data (e.g., personal information). The server system divides the user data into multiple components. Each device in a set of devices receives a component of the user data for storage. When the user accesses a web page through a host device that includes one or more data fields into which user data can be entered, the host device receives the components of the user data from the devices in the set. The host device reassembles the user data based on the received components. When an authorization gesture is performed by the user with a storage device from the set of devices, the host device inserts the user data in the data field.

### CROSS-REFERENCE TO RELATED APPLICATIONS

This application claims the benefit of provisional application 61/730,093, filed on Nov. 27, 2012, and incorporated by reference herein in its entirety.

### BACKGROUND

1. Technical Field

The described embodiments pertain to systems and methods for data assembly, data transfer and data storage.

2. Description of the Related Art

With the increasing use of electronic modes for conducting personal and business affairs and the increasing popularity of electronic entertainment, individuals increasingly need to enter details into electronic systems.

For example, to use an online shopping service one typically must register with the website by providing identification, billing and delivery data for storage and later use by the merchant; or provide this data each time a transaction is performed. Even if the data is stored by the merchant, the user will need to go through a login process, entering her username and password each time she accesses the site. This can be quite burdensome for the person providing the data. Moreover with the popularity of portable computing devices, many of which do not have full sized keyboards, this task requires some dexterity to perform. The result is that many users of online shopping services abandon their purchases due to difficulty with this process, leading to lost sales by the merchant.

There are also many other contexts in which a user is required to provide data in a structured fashion for transmission via a communications channel to another party. To give but one example, many software applications running on a computing device may require data to be entered in a structured manner for transmission to another device, e.g., to buy goods or services, register user interest in some event or activity, make a booking, enter login credentials etc. These situations also give rise to the same problems as the online shopping example given above, in that a user needs to enter data in a structured fashion into the application.

### SUMMARY

The described embodiments provide methods, computer readable storage mediums, and systems for data assembly, data transfer and data storage. A user registers with a server system and provides user data (e.g., personal information). The server system divides the user data into multiple components. Each device in a set of devices receives a component of the user data for storage. The set of devices may include, for example, a host device, the server system, and one or more storage devices.

Through the host device the user accesses web pages from one or more web servers. For example, the user may access web pages to purchase an item from a merchant or to perform other types of transactions. When a web page accessed by the host device includes one or more data fields into which user data can be entered, the host device receives the components of the user data from the devices in the set. The host device reassembles the user data based on the received components. When an authorization gesture is performed by the user with a storage device from the set of devices, the host device inserts the user data in the data field. The authorization gesture includes one or more physical movements performed by the user with the storage device. The performance of the authorization gesture by the user indicates that user wishes for the data field to be automatically filled by the host device.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a schematic block diagram illustrating a set of devices operating together according to one embodiment.

FIG. 2 is a functional block diagram illustrating a card device according to one embodiment.

FIG. 3 is an interaction diagram illustrating data flow between devices during device connection according to one embodiment.

FIG. 4 is an interaction diagram illustrating data flow between devices in a process of page recognition according to one embodiment.

FIG. 5 is an interaction diagram illustrating data flow between devices in a process for data assembly according to one embodiment.

FIG. 6 is an interaction diagram illustrating data flow between devices in a process for data transfer authorization according to one embodiment.

FIG. 7 is a flow chart illustrating a process for filling a data field according to one embodiment.

FIG. 8 is a schematic block diagram illustrating a set of devices operating together according to another embodiment.

FIG. 9 is a block diagram illustrating a functional view of a typical computer system for use as a host device, storage device, server system, and/or web server according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

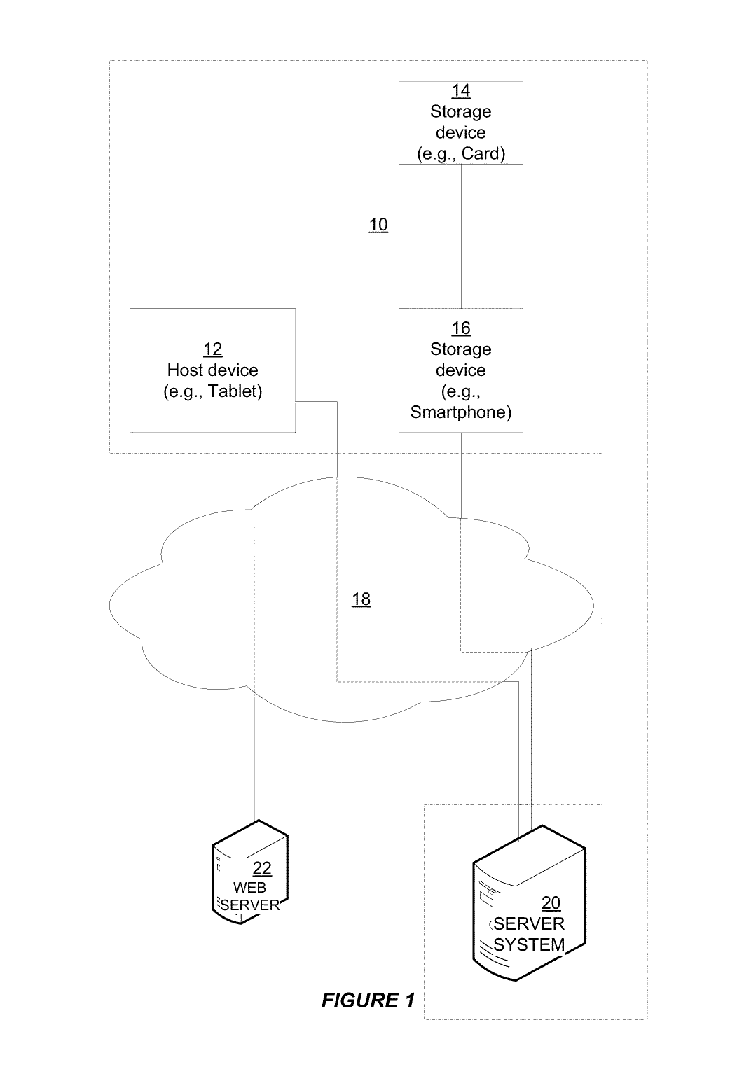

FIG. 1 is a schematic block diagram illustrating a set of devices 10 operating together according to one embodiment. The set of devices 10 includes a host device 12, two storage devices 14 and 16, and a server system 20. The devices 12, 14 and 16 are in data communication via a network 18 with the server system 20. The host device 12 is also in data communication with a web server 22 which hosts a website comprising a series of web pages. As will be appreciated in a system of this type many users may have similar sets of devices operating in a similar fashion. In this case the server system 20 will form part of many sets of devices for many users. However for clarity only the set of devices associated with a single user are illustrated.

In one embodiment, a user of the host device 12 is seeking to perform a data transfer from the host device 12 to the web server 22. This data transfer can be, for example, the transmission of the user's personal data to the web server 22 to perform a transaction, such as purchasing an item from a merchant via the web server 22 or performing a banking transaction on a bank's web server 22.

In this example the host device 12 is a mobile computing device, such as a laptop computer or tablet computer. The host device 12 connects to the network 18 via any suitable wired or wireless network (or combination of them) such that it can exchange data with other devices. For the present example we assume that the host device 12 is a tablet computer, such as an iPad by Apple Inc., of Cupertino, Calif. or a Galaxy Tab by Samsung Electronics Co. Ltd., of Suwon, South Korea, and that the host device 12 communicates with web server 22 and server system 20 via a network 18 such as the Internet.

In this example the storage device 16 is another mobile computing device, which may be of a different or same type as the host device 12. In this example the device 16 is a smartphone such as an iPhone by Apple Inc., communicating with the network 18 via a cellular telecommunications network such as a GSM, WCDMA or LTE mobile network or a local area network such as a Wi-Fi or Bluetooth network.

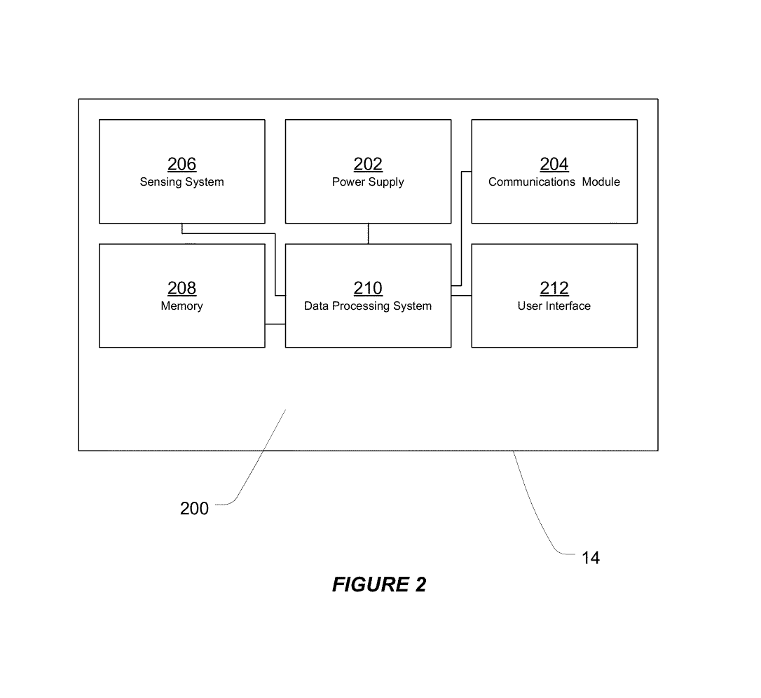

The device 14 is another mobile computing device. In this example the device 14 is a special purpose token in the form of a card that can store data and communicate with another device via a communication channel. The communication channel may be a limited-range wireless connection, such as a Bluetooth connection (e.g., Bluetooth low energy connection). However, in other embodiments, the device 14 may be a mobile phone, a tablet computer, a personal digital assistant (PDA), or token/fob. FIG. 2 is a functional block diagram illustrating the card device 14 used in this embodiment. The device 14 has a device body 200 that carries components of the card device 14. In this case the body is shaped so as to give the device 14 the form factor of a transaction card (e.g. bank card, debit card, credit card), but may be any other form factor including, but not limited to, a key fob money clip, key, lanyard, watch, pen, coin, clip, tag and buckle form factors.

The device 14 includes: a power supply 202 (e.g., in the form of battery), a communications module 204, a sensing system 206, a memory 208, a data processing system 210, and a user interface 212. The communications module 204 enables communications with other devices (e.g. via a limited-range wireless communication channel such as Bluetooth, ZigBee (IEEE 802.15), wireless USB, WiFi, near field communications, or other personal area network communication channels). The sensing system 206 provides a mechanism to sense movement of the device 14. In one embodiment, the sensing system 206 operates by sensing acceleration and/or orientation of the device 14. For example the sensing system in various embodiments includes one or more accelerometers, gyroscopes, or other devices configured to sense forces applied to the device 14 in one or more dimensions. The memory 208 is volatile and/or non-volatile memory. The memory 208 stores thereon data which may be transferred as described below or data needed to control the operation of the device 14.

The data processing system 210 is configured to control operations of the device 14 as described below. The data processing system 210 can include, for example, a processor, real time clock, and AES encryption hardware, and an optional user interface 212 (e.g., in the form of one or more buttons, a display, LEDs, an LCD display, still or video camera, a buzzer or speaker, a mechanical switch or other interface element, via which information may be conveyed to the user or inputs received from the user).

In addition to storing a portion of the user's data, the device 14 can be used in an authorization scheme in one embodiment. This scheme includes a user performing an authorization action with the device 14 that can be sensed by the device 14, in order for the data transmission from the host device to be completed. The authorization action can be any physical action taken with respect to the device 14—e.g., sensing that the device 14 is being held in a predetermined fashion, that it has been moved in a predetermined fashion either in an absolute sense or relative to another device. This authorization action may be sensed by the device 14 itself (e.g. using an onboard touch sensor, accelerometer, imager or the like) or by another device (e.g. using a camera, or motion sensor of (or connected to) to the device 16). Sensors on both devices may cooperate to sense motion of the device 14. As will be appreciated the sensed motion could be sensed relative to the device's 14 original position and/or orientation or relative to device 16 or relative to the direction of gravity.

In one embodiment the authorization action is a physical gesture, which may also be referred to as an authorization gesture. The authorization gesture is performed by performing one or more physical movements with the device 14 in a predetermined manner. In this example the device 14 includes a 3-axis accelerometer that senses motion of the device 14. The output of the sensing system 206 is provided to the processor 210 which analyses the sensor output and determines according to heuristic rules what type of gesture has been performed. For example, the gesture could be a tap, or series of taps, swipe, or rotation of the at least one device, or a combination of such actions.

In order to indicate to the host device 12 that the gesture has been performed, the device 14 sends data representing the performance of the gesture to the host 12 via a protocol message as described below. This message can include a type of gesture performed, or simply a status message indicating that some gesture has been sensed. Alternatively, instead of processing the sensor data onboard the device 14, data representing the output of the sensing system 206 can be transmitted to the host device 12, which can determine correct performance of the gesture.

Since the device 14 is a battery powered device, the sensing system 206 can remain inactive until needed. In one embodiment, the sensing system 206 is only activated once the device 14 receives a trigger signal from another device telling it that a gesture is needed. The trigger signal in one embodiment is the request for transmission of the device's stored component of the user data, as opposed to a dedicated signal.

In one embodiment, the functionality of device 14 is implemented in another device, such a smartphone or similar, that is capable of carrying out the function of the device 14 as described herein.

In use, each of the devices 12, 14, 16 is able to communicate with the server system 20 via network 18, so that they can cooperate to enable storage, assembly and transmission of data as described below. The device 14 connects to the server via the device 16, hence the device 16 may be referred to herein as an intermediate device. The devices 14 and 16 communicate via a limited-range connection. In one embodiment, data passed through device 16 by device 14 is encrypted so it can only be decrypted be its intended destination and not by device 16 or any other intermediary.

The server system 20 may store part of each user's data. In one embodiment, the server system 20 performs the following: receives protocol messages and maintains state information for the set of devices 10; sends protocol messages to the devices in the set 10 to update the system's state; provides a means of capturing and loading data into the devices 12, 14, 16; allows a user to re-assemble the stored data for transmission from the host device 12 and edit the stored data; and act as a certificate authority for the system to create, distribute and revoke certificates and hash keys when a device is added or removed from a device set 10 and/or when a user wishes to change the stored data.

The role of each of the devices 12, 14 and 16 and the server system 20 in the process of data assembly, data transfer and data storage will be described further below.

### Device Registration and Enrolment

In one embodiment, initial device setup involves a registration process. In the registration process, the user accesses a website associated with the server system 20, e.g., using a browser running on one of the devices, such as the host device 12. In one embodiment, the browser connection is made using a Payment Card Industry (PCI) compliant mechanism like TLS 1.2 or SSL 3.0 with 256 bit RSA or AES encryption. During this session the user establishes a user account with user provided credentials, which can include one or more of the following: user name, password, e-mail address, a device identifier associated with the card device 14 (e.g., a unique card identification number, barcode, QR code etc. printed on the card device 14), an account number (generated by the system during registration), a one time key or other system for two factor authentication.

As part of the registration process the user's details and account information may optionally be confirmed by the user by sending an e-mail to the user using the supplied email address. The email contains a link back to web page, which when followed by the user authorizes the registration and confirms that the e-mail address provided at registration is accessible by the user.

During registration or after the user account is established, the user can provide user data for storage. The user data can be, for example, personal information of the user that is to be used to automatically fill data fields in a web page or an application to avoid the need to re-type these details each time they are needed. The user data may include one or more of the following: name(s), date of birth, residential address, billing address, delivery address, email address(s), telephone number(s), nickname or preferred names(s), transaction card details (e.g., type, holder name, card number, expiration date, card security code/card verification value) for one or more transaction cards (e.g., debit or credit cards), account/client number for one or more store accounts, bank account details, user name and password for a number of different services, seating preferences (e.g., for venues, airlines etc.), dietary preferences (e.g., allergies or the like), employment data (e.g., job title, employment date, company, work contact details), club membership details (number, membership date, expiration date), loyalty program enrolment details (program, status, points), and one time key or other system for two factor authentication.

Once the account is established, the user associates a group of devices with her account to define the set 10 of devices over which her data will be split (divided) for storage. This is performed by connecting each device to the server system 20 via a network connection. The connection may be made either with a proprietary application that is used for enrolling and configuring the device, or via a web page using a secure connection using the keys provided with the browser or operating system on which the application is running For each device being enrolled, the user provides login credentials (e.g., user name, password, email address and card id) provided during registration to the server system 20 through the device. The server system 20 generates a public key security certificate for the user which is automatically downloaded and installed on the device for use with the system 20.

At the end of the enrolment process for a device, the device in the device set 10 has a certificate containing its private and public keys for a public key encryption system. The server system 20 has a listing of the public and private keys associated with the devices in the device set 10 as well as its own private key. As noted above, it the case of card device 14 the intermediate device 16 acts as a proxy and relays the data stream between the server system 20 and device 14.

After device enrolment has been completed, the server system 20 splits the received user data into multiple portions (may also be referred to as “components”) for storage among the devices in the device set 10 using a process that will be described in greater detail below. As will be appreciated it may be the case that only some devices (12, 16) in the device set 10 will be capable of operating in the role of the host device, which is the device that request the user's data for assembly and date transfer but all devices are capable to performing the role of a data storage device.

The server system 10 encrypts each portion of the split data so that it may be decrypted by any of the devices that are capable as acting as a host device. Specifically the server system 20 encrypts each user data portion for each device (12, 16) within the device set 10 that may request it. In one embodiment, when the encryption has been performed the user data and the private keys for each device are deleted from the server system 20 except for any portion of the data that is to be stored by the server system 20 and any private keys of the server system 20.

In the present example, the device set 10 includes the server system 20, a card device operating as storage device 14, a tablet computer operating as the host device 12, and a smartphone operating as storage device 16.

The portion of the user data that is stored on the card device 14 is referred to here as PI(card). The server system 20 encrypts PI(card) using the card device's private key and the host device's public key to generate crypt(public_key(tablet), private_key(card), PI(card)), referred to as PEI(tablet, card). This is sent across a secure link to the card device 14 for storage in the card device's memory 208. Since the smartphone 16 can also operate as a host device PEI(phone, card) is also stored on the card device 14.

During a process for assembling data by the tablet computer 12 which includes the data from the card device 14, the tablet computer 12 requests the card device's portion of the user data. The card responds with PEI(browser, card). Since the portion of the data stored on the card device 14 was pre-encrypted by the server system 20 prior to being provided to the card device 14 for storage, the card device 14 does not need to perform any cryptographic operations to encrypt the data prior to responding to the request. By pre-encrypting the data, it minimizes the processing required by the card device 14 thereby maximizing the battery life of the card device 14.

To modify the data stored among the devices or to add/remove a device, the user reconnects the devices in the device set 10 to the server system 20 and performs the changes. Re-connection of the devices may be performed asynchronously, so that devices are updated as they are connected. Until all devices are updated, the system 20 may not be used for re-assembling data for transmission.

When the user data is changed or a device is added or removed from the user's device set, the following occurs: new public and private keys are created for each device in the set 10, the user data is re-split among the devices in the set 10 and server system 20. Additionally, the split data is re-encrypted. New keys and the re-encrypted data blocks are transmitted to the respective devices across a secure connection.

The data transmitted to each device in the set 10 replaces the user data already stored on the device. When a device in the set 10 receives its respective data portion and keys, it notifies the server system 20 that the update is complete. In one embodiment, to prevent data inconsistencies no other protocol transactions are permitted during the update until each device confirms that the update is complete. The server system 20 implements this restriction by ignoring other protocol messages.

As will be appreciated the data storage scheme can be extended to separately encrypt the user data in a structured way, e.g., as specific fields of personal information. When data is stored like this a request for user data from a device in the set will contain a list of the fields required and only the required fields are transmitted to the host device 12 by the device. This reduces the amount of redundant transmission and hence improves battery life on the transmitting device.

If a device in the set 10 is lost or stolen, the server system 20 revokes the device's certificate and sends a revocation message to each of the other devices in the set 10. The devices that receive the revocation message delete any certificates and information associated with the revoked device.

In one embodiment, each of the data connections described herein is implemented as a secure connection using a PCI compliant SSL 3.0 or TLS 1.2 connection protocol. Connections can also be implemented on a pre-defined communication port on each device so that a plain text to encrypted handover (e.g., StartTLS) is not needed.

### Data Storage

To enhance the security of the user data, the user data is split and shared among the devices in the device set 10 using a secret sharing system such as that disclosed in publications titled “Safeguarding cryptographic keys” by G. R. Blakley, Proceedings of the National Computer Conference 48: 313-317 (1979) and “How to share a secret” by Adi Shamir, Communications of the ACM 22 (11): 612-613(1979). The publications are incorporated by reference herein in their entirety.

To reassemble the user data, the host device 12 needs its portion of user data and the data portions from other participating devices. In one embodiment, prior to reassembling the data, the host device 12 requires that the user provide a proper passcode that authenticates the user. The number of devices participating in the secret sharing system of the user data may be less than the number of devices in the device set 10. As part of reassembling the user data, the host device 12 requests from the devices participating in the secret sharing system the portions of user data stored by the respective devices. The host device 12 receives the portions of requested data. The host device 12 decrypts the portions of user data and reassembles the user data so that it can be used, for example, to automatically fill fields included in a browser window or another application running on the host device 12.

As noted above, the portions of user data are stored in pre-encrypted form on each device using the device's private key and the public key of the host device 12 so as to make a response to a data request from the host device 12 fast and simple. In one embodiment, the transmission of data by a data storing device involves performing a table lookup based on an identifier associated with the host device 12 to identify the correct data to transmit. The identified data is transmitted in pre-encrypted form to the host device 12. As noted above, the pre-encryption of the user data is done by the server system 20 during the splitting of the user data.

### Example of Performing Auto-Fill on a Website

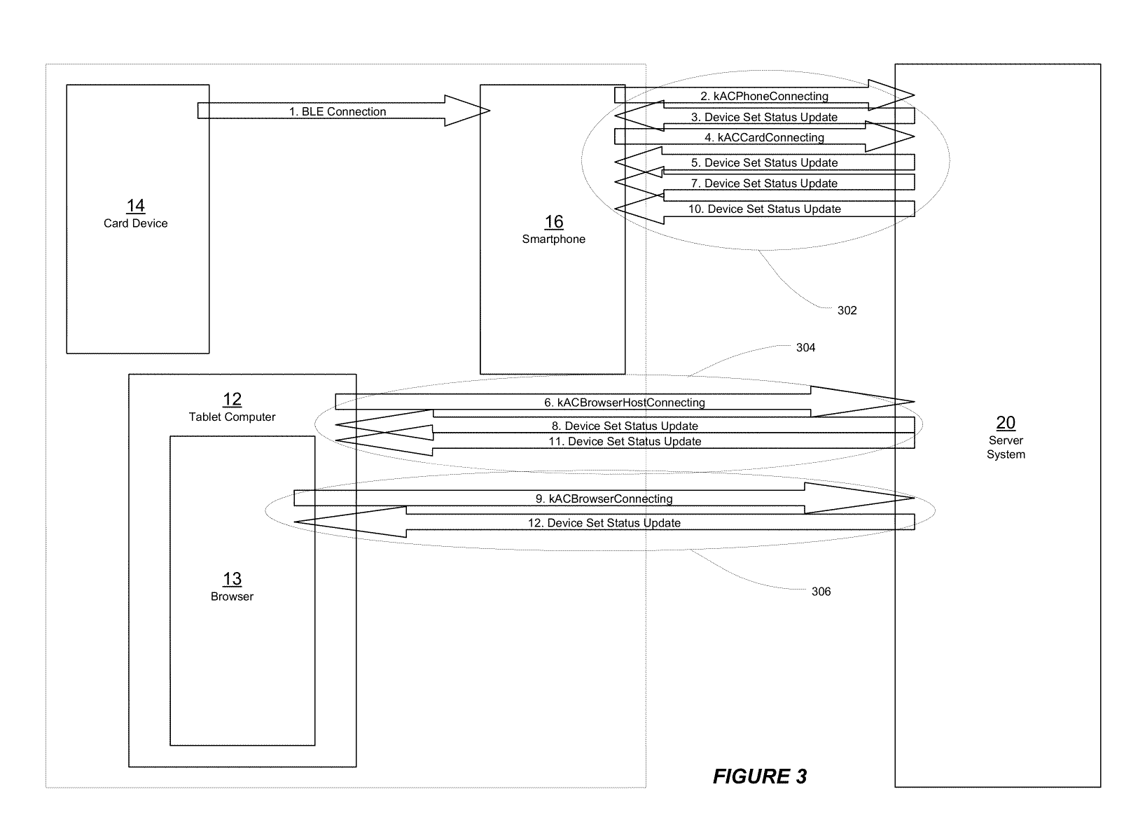

An exemplary use of the devices of FIG. 1 is now described in connection with FIGS. 3 to 5 to illustrate how to auto-fill functionality in a form of a website hosted by the web server 22.

In this example a tablet computer is operating as the host device 12 and running a web browser application. Additionally, a card device is operating as storage device 14 and a smartphone is operating as storage device 16. The tablet computer 12, card device 14, and smartphone 16 are each running a software application that enables them to implement an embodiment of the inventive processes described herein.

### Connection of the Set of Devices to the Server

The process begins in FIG. 3 with the device authentication and the establishment of communications channels and connection of each of the devices in the set 10 to the server system 20. The devices 12, 14, 16 can connect and disconnect to the server system 20 in any order, as they are turned on/off, enter/exit range etc. A typical scenario is described below. Numbers in brackets ( ) in each step refer to numbered data flows in the associated interaction diagrams (FIGS. 3 to 6).

The card device 14 establishes (1) a limited-range communication channel (e.g., a BLE (Bluetooth Low Energy) connection) with the smartphone 16 using, for example, standard BLE functionality of the smartphone's operating system. The smartphone 16 is notified of the device connection via the standard operating system notification system and the smartphone 16 saves this card connected state. The smartphone 16 establishes (2) a network connection with the server system 20 and sends a kACPhoneConnecting message telling the server system 20 that the smartphone 16 wants to connect to it. The server system 20 looks the smartphone 16 up in a database of registered devices and if present in a recognized device set, server system 20 updates the database to indicate the smartphone 16 is present. The server system 20 then sets the smartphone 16 as the primary phone device and responds (3) with a Device Set Status Update message to each connected device in the device set 10. At this stage the phone is the only connected device, so that the Device Set Status Update message only goes to the smartphone 16.

The Device Set Status Update message is issued by the server system 20 upon receiving a Connecting or Connected message from a device, or upon a network socket disconnection event or other communications interruption relating to a device that is identifiable to the operating system of the server system 20. This message is sent to all devices currently connected to the server system 20 in the device set containing the connecting or disconnecting device. The Device Set Status Update message contains the state of all devices, along with any additional device states stored by the server system 20. Additionally, a list of currently connected devices is also included in the message structure. This allows a device to check that it is connected, but not primary, and then request to become primary if the user chooses to do so.

When the card device 14 connects to the smartphone 16, the smartphone 16 sends (4) a kACCardConnecting message to the server system 20. If the card device 14 is connected to the smartphone 16 before the smartphone 16 is connected to the server system 20 then the smartphone 16 sends a kACCardConnecting message to the server system 20 as soon as the smart smartphone 16 connection to the server system 20 is acknowledged with a Device Set Status Update message that indicates the phone is connected. In response to receiving kACCardConnecting message, the server system 20 looks the card device 14 up in its database and if the card device 14 is present in a device set, it updates the database to indicate the card device 14 is present. The server system 20 sets the card device 14 as the primary card device 14 and responds by sending (5) a Device Set Status Update message to each connected device in the device set.

Next the tablet computer 12 connects to the server system 20. The tablet computer 12 can be running a modified web browser (e.g., having a plug-in to perform the methods described herein) or a special purpose application which has a browser functionality and is used to access websites (on which auto-fill may be performed). The tablet computer 12 running on device 12 establishes (6) a network connection to the server system 20 and sends kACBrowserHostConnecting message telling the server system 20 that it is wants to connect to it.

The server system 20 then looks the tablet computer 12 up in its database and if the device 12 is present in a device set the server 20 updates its database to indicate the tablet computer 12 is present. The server system 20 sets the tablet computer 12 as the primary host device and responds (7, 8) with Device Set Status Update message to each connected device in the device set 10. As will be noted two Device Set Status Update messages are sent.

In one embodiment, in order to interact with a website hosted by the web server 22, the tablet computer 12 needs to run a web-browser application, thus the next steps in the process involve activating a browser 13 and initiating system software such that the browser 13 can take part in the auto-fill process. The browser 13 can be a special purpose browser forming part of a software application or suite of applications that implement the processes described herein or may be a general purpose browser running a plug-in that provides functionally to implement the processes.

When user wishes to access a web page using tablet computer 12 the user activates the browser 13. The browser 13 establishes (9) a network connection with the server system 20 and sends kACBrowserConnecting message telling the server system 20 that it is wants to connect to it.

The server system 20 looks the browser 13 up in its database and if the browser 13 present in a device set the server system 20 updates the database to indicate the browser 13 is present. The server system 20 sets the browser 13 as the primary browser and responds (10, 11, 12) with Device Set Status Update message to each connected device in the device set 10 and the browser 13.

The tablet computer 12 can now display the current connected state for the card device 14, smartphone 16 and server system 20 to the user, representing the data received in Device Set Status Update message. In this state, when a user browses to a website in the browser 13, an indicator in the tablet computer 12 shows the status of the devices. The states displayed can include: no server system connection, no smartphone 16 connected, no card device 14 connected, all devices connected, all devices connected but tablet computer 12 not primary browsing device, and all devices connected but page not recognized.

If the tablet computer 12 is not currently the primary browsing device, the status connection indicator will function as a “request to become primary” button, at which time a kACBecomePrimary message (not shown) will be sent to the server system 20.

### Browsing to Web Pages Containing Forms

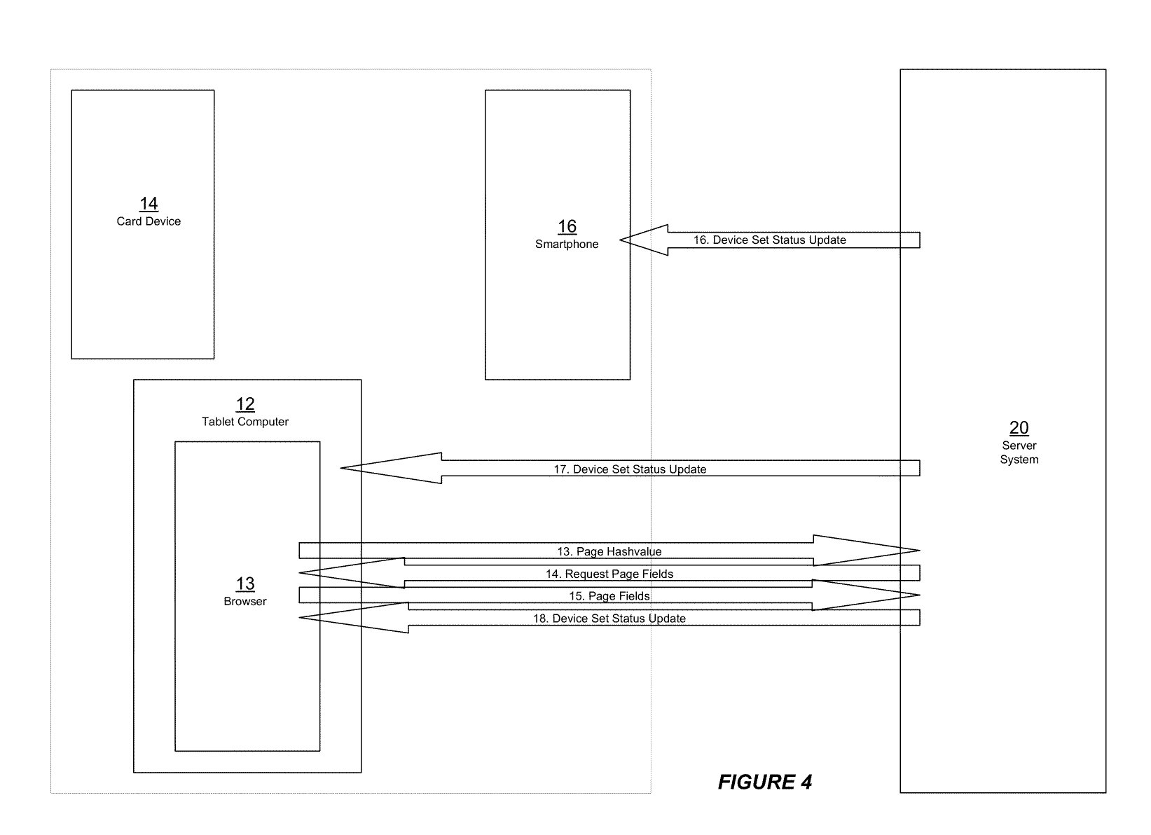

At this point in the process, the when a user of tablet computer 12 browses to a certain recognized web page it is possible assemble data for auto-filling a form on the web page with user data stored among the device. This process, illustrated in FIG. 4, begins with analyzing a web page and determining what data is needed to be assembled to complete the form.

When a user browses to a web page, the browser 13 scans the contents of the page to identify the page. To perform this scan the browser 13 injects a JavaScript program into the page being viewed. The JavaScript program generates a page identifier, e.g., by taking the Page Title and Domain Name and creates a Hash value using a hash function like MD5 or SHA-1.

The Browser 13 sends (13) a Page Hash value message to the server system 20. The server system 20 checks the Page Hash value message against a page database to determine if the page is known to include data fields (which can happen in shopping sites where the site has the same page name and domain across its checkout/payment system). If the page is not included in the page data the server system 20 sends (14) a RequestPageFields message to the browser 13. The RequestPageFields message requests information from the browser 13 on whether the page includes data fields and if it does what fields are included. In one embodiment, the server system 20 sends the RequestPageFields message even if the page is included in the page database. This may be done in order to determine if the content of the page has changed (e.g., fields added or removed).

If the browser 13 receives a RequestPageFields message the JavaScript responds by sending (15) a Page Fields message to the server system 20 with information regarding whether the page includes fields. The server system 20 checks the information received in Page Fields message and sets an internal BrowserPageRecognised state indicating whether the page is recognized as including data fields that can be filled or not recognized as including data fields. If a page is recognized as including data fields that can be filled, the server system 20 sends (16,17,18) a Device Set Status Update message to each device 12 and 16 and the browser 13 to indicate that the web page is able to be auto-filled.

### Data Retrieval and Assembly

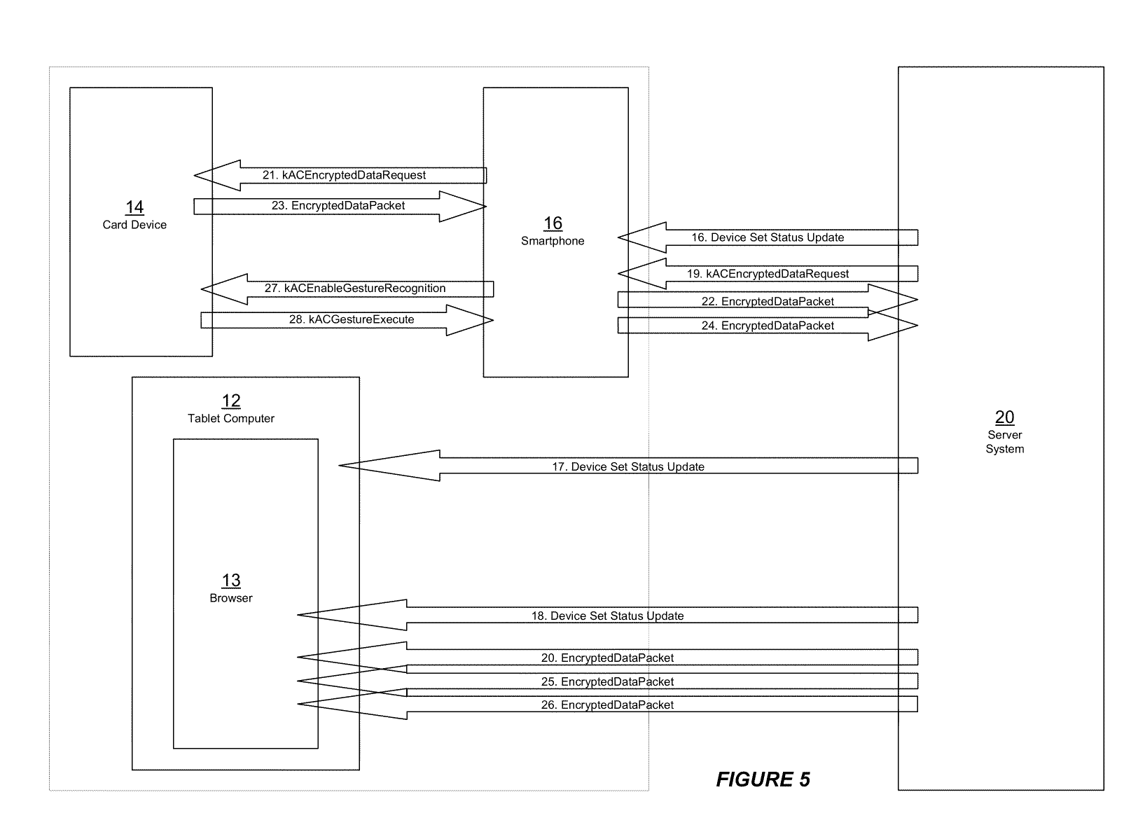

Once the server system 20 has been established that the user has browsed to a suitable web page, the user can initiate retrieval of their data and assembly of it for transmission to the web server 22 as a completed web page form. This process is illustrated in FIG. 5. If the current web page is recognized, the server system 20 sends (19) a kACEncryptedDataRequest message along with the Public Key of the browser 13 to each device in the Device Set that stores at least one portion of the user data needed to auto-fill the data fields of the web page.

The server system 20 also sends (20) an EncryptedDataPacket message containing its share of the user data to the browser 13. When the smartphone 16 receives the kACEncryptedDataRequest message from the server system 20, it sends (21) a kACEncryptedDataRequest message to the card device 14. It also sends (22) an EncryptedDataPacket message containing its encrypted portion of the user data corresponding to a Browser Public Key to the server system 20. When the card device 14 receives the kACEncryptedDataRequest (21) from the smartphone 16, it sends (23) an EncryptedDataPacket message containing its encrypted portion of the user data corresponding to the Browser Public Key to the smartphone 16.

The smartphone 16 receives the EncryptedDataPacket from the card device 14 and passes (24) that data packet as an EncryptedDataPacket message to the server system 20. The server system 20 receives the EncryptedDataPacket message from the smartphone 16 as a proxy for the card device 14 and passes (25) that data packet as an EncryptedDataPacket message to the browser 13. The server system 20 receives the EncryptedDataPacket message with the data portion of smartphone 16 and it passes (26) that data as EncryptedDataPacket to the browser 13.

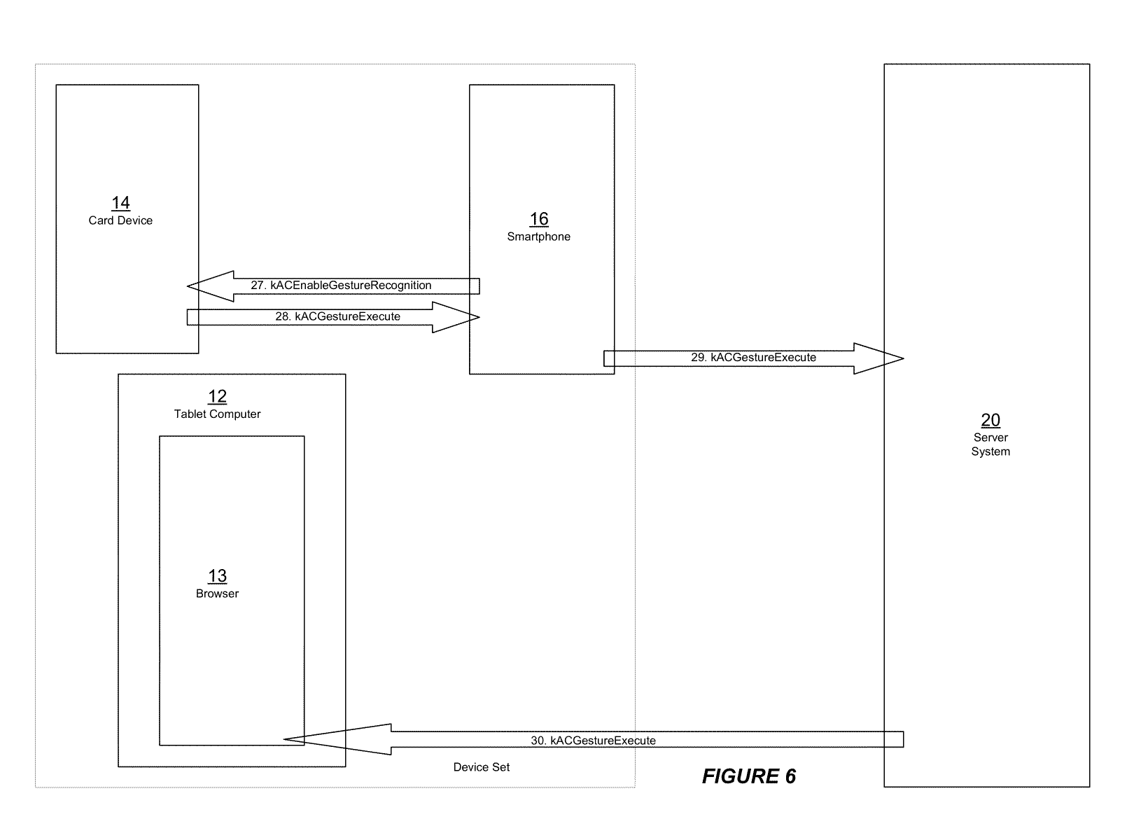

At this point the browser 13 possesses the encrypted portions of the user data stored on the card device 14, smartphone 16 and server system 20, as well as any portion it may store locally. The portions are decrypted and reassembled by the browser 13 and the field data of the webpage is automatically filled by the browser 13. In one embodiment, the decryption and auto-fill process needs an authorization process to be completed. In this example the browser waits for confirmation that an authorization action has been performed by the user with the card device 14. This process is illustrated in FIG. 6. It should be noted that this authorization process may be omitted in some embodiments.

### Authorization Action

Referring to FIG. 6, using the Device Set Status Update messages, the smartphone 16 monitors the connected state of the card device 14, smartphone 16, browser 13 as well as the Page Recognized state and sends (27) a kACEnableGestureRecognition message to the card device 14 asking it to enable its gesture recognition functionality when all states are true. The smartphone 16 also sends a kACDisableGestureRecognition (not shown) if any of the devices disconnect or the page is not recognized to conserve battery life on the card device 14.

Upon receiving the kACEnableGestureRecognition message, the card device 14 enables its accelerometer gesture recognition code, and monitors the sensor output waiting for the user to execute a gesture with the card device 14. When the user executes the gesture using the card device 14 and the gesture recognition routine recognizes the gesture as an authorization gesture, the card device 14 sends (28) a kACGestureExecute to the smartphone 16, indicating the gesture has been executed and optionally identifying the gesture.

The smartphone 16 then sends (29) a kACGestureExecute to the server system 20, indicating the gesture has been executed and optionally identifying the gesture. Similarly the server system 20 sends (30) a kACGestureExecute message to the browser 13 indicating that the gesture has been executed and optionally identifying the gesture. Upon receiving the kACGestureExecute message, the EncryptedDataPacket with data stored by the card device 14, the EncryptedDataPacket with data stored by the smartphone 16, and the EncryptedDataPacket with data stored by the server system, the browser 13 decrypts and recombines the data portions. The browser creates the auto-fill data for the page and inserts the data into the fields on the page. Thus, the data is assembled for transmission to the web server 22. The data transmission to the web server 22 can be initiated by the ordinary mechanism within the web page, such as by the user clicking a “submit” button or the like.

In one embodiment, the tablet computer 12 does not request the portions of user data from the devices until the tablet computer 12 receives an indication that an authorization gesture has been performed with the card device 14. In another embodiment, the data portions are requested when a web page that can be auto-filled is identified but the fields are not auto-filled until the indication of an authorization gesture being performed is received.

The user continues to the next page of the website, e.g., the next phase of the checkout process, and if there are additional web pages that require auto-filling of data, the pages are recognized and data assembly process is repeated.

The process of automatically filling data fields has been described in this example with respect to pages from a web server. However, the processes described herein may be applied to any other type of documents including data fields, such as a page of a mobile application, a word processor document, a spreadsheet, etc.

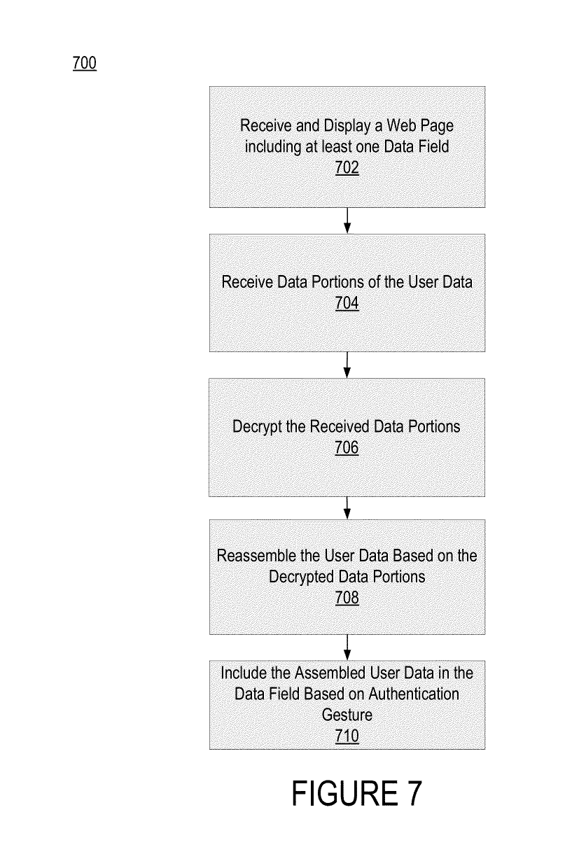

FIG. 7 is a flow chart illustrating a process 700 for filling a data field according to one embodiment. Those of skill in the art will recognize that other embodiments can perform the steps of FIG. 7 in different orders. Moreover, other embodiments can include different and/or additional steps than the ones described herein.

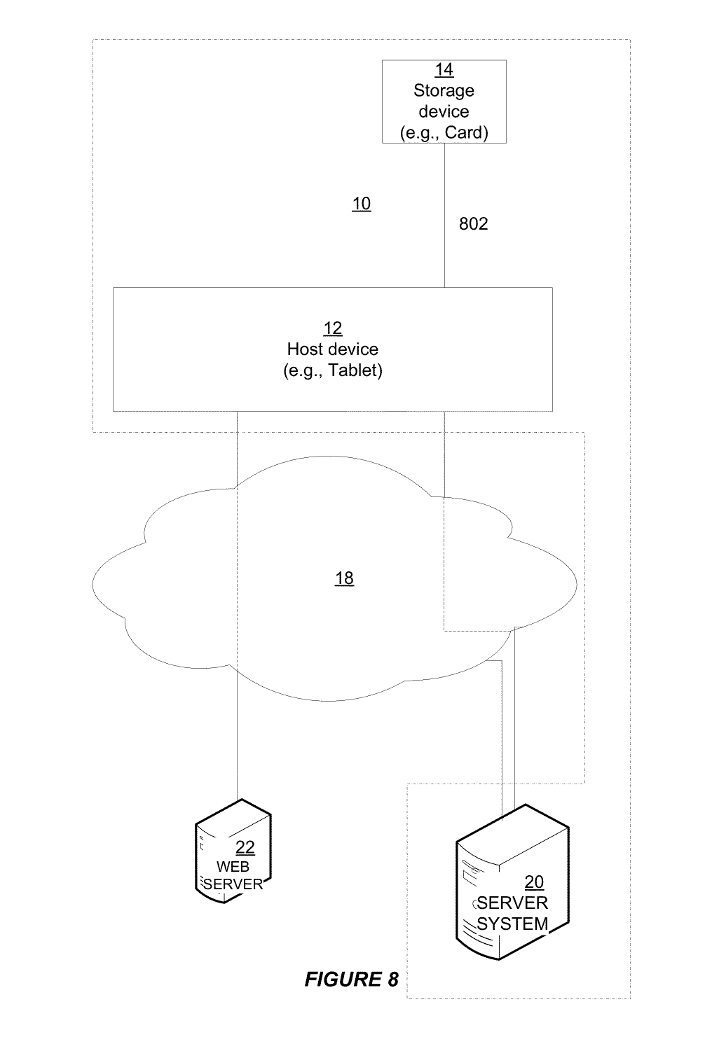

For purposes of this example, it is assumed that the set 10 of devices include the host device 12, the storage device 14, and the server system 20 as illustrated in FIG. 8. A limited-range wireless connection 802 is established between the host device 12 and the storage device 14. The host device 12 and the storage device 20 are registered with the server system 20. It is further assumed that the server system 20 divided the data into at least three portions, with the host device 12, the storage device 14, and the server system each storing at least one portion.

Returning to FIG. 7, the host device 12 receives 702 and displays a web page from the web server. The web page includes at least one data field in which data can be entered (i.e., the data field is receptive to data). In one embodiment, the web page enables the purchase of an item from a merchant (e.g., a shopping cart checkout page). In other embodiment, the web page is for performing other types of transactions, such as for logging into a system, performing a banking transaction, filling out a form, etc.

The host device 12 receives 704 the data portions of the user data from the storage device 14 and the server system 20. The host device 12 receives the storage device's data portion via the limited-range wireless connection 802. In one embodiment, the host device 12 receives the data portions from storage device 14 and server system 20 after it is determined that the web page includes at least one data field that can be filled. In another embodiment, embodiment, the host device 12 receives the data portions after the host device 12 determines that an authentication gesture was performed with the storage device 14.

The host device 12 decrypts 706 the received data portions and reassembles 708 the user data based on the data portions. The host device 12 inserts 710 the assembled user data in the data field based on an authentication gesture performed with the storage device 14.

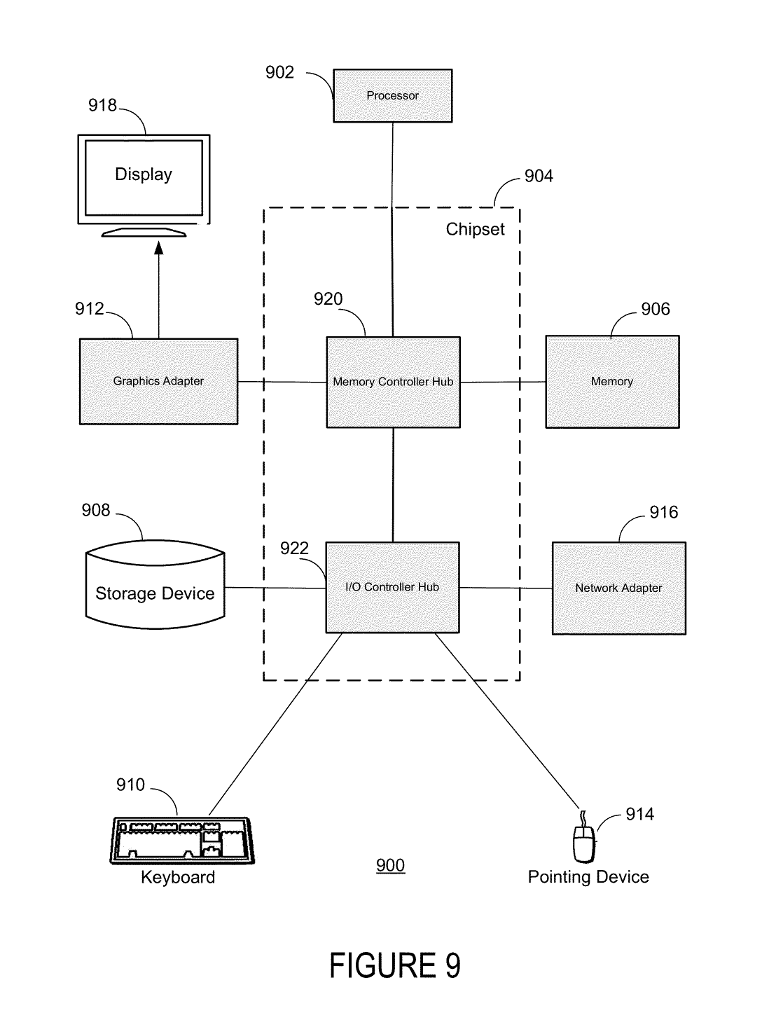

FIG. 9 is a block diagram illustrating a functional view of a typical computer system for use as one or more of the entities (the host device 12, storage device 14, storage device 16, and/or server system 20) of FIGS. 1 and 8 according to one embodiment.

Illustrated are at least one processor 902 coupled to a chipset 904. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O controller hub 922. In another embodiment, the memory 906 is coupled directly to the processor 902 instead of the chipset 904.

The storage device 908 is a non-transitory computer-readable storage medium, such as a hard drive, compact disk read-only memory (CD-ROM), DVD, or a solid-state memory device. The memory 906 holds instructions and data used by the processor 902. The pointing device 914 may be a mouse, track ball, or other type of pointing device, and is used in combination with the keyboard 910 to input data into the computer system 900. The graphics adapter 912 displays images and other information on the display 918. The network adapter 916 couples the computer system 900 to the network 18. Some embodiments of the computer system 900 have different and/or other components than those shown in FIG. 9.

The computer system 900 is adapted to execute computer program modules for providing the functionality described herein. As used herein, the term “module” to refers to computer program instruction and other logic for providing a specified functionality. A module can be implemented in hardware, firmware, and/or software. A module is typically stored on the storage device 908, loaded into the memory 906, and executed by the processor 902.

A module can include one or more processes, and/or be provided by only part of a process. Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

The types of computer systems 900 used by the entities of FIGS. 1 and 8 can vary depending upon the embodiment and the processing power used by the entity. For example, a host device 12 that is a mobile phone typically has limited processing power, a small display 918, and might lack a physical keyboard 910 and a pointing device 914. The server system 20 and the web server 22, in contrast, may comprise multiple blade servers working together to provide the functionality described herein.

Some portions of above description present the features of embodiments in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by real time network operating systems.

The disclosure of the embodiments is intended to be illustrative, but not limiting, of the full scope of the embodiments, which is set forth in the following claims.

What is claimed is:

1. A computer-implemented method comprising:
displaying, on a host device, a web page received over a network from a web server, the web page enabling the purchase of an item from a merchant and including at least one data field;
requesting, by the host device from a mobile device, a first component of user personal information stored on the mobile device, the user personal information previously split into a plurality of components, the plurality of components including at least the first component and a second component, the second component of the personal information stored by an entity different than the mobile device;
receiving, by the host device from the mobile device, the first component of the personal information;
assembling, by the host device, the personal information based on the received first component and the second component of the personal information;
receiving, by the host device from the mobile device, a notification including information indicating that an authorization gesture was performed by the user through one or more physical movements of the mobile device;
inserting, by the host device, the assembled personal information in the data field based on the notification received from the mobile device; and
transmitting, by the host device, the personal information to the web server.

2. The method of claim 1, wherein the entity storing the second component of the personal information is the host device.

3. The method of claim 1, wherein the entity storing the second component of the personal information is a server system that split the personal information into the plurality of components, wherein the server system transmits the second component to the host device for assembling the personal information.

4. The method of claim 3, wherein the plurality of components includes a third component that is stored by the host device, the personal information assembled based on the first, second, and third components.

5. The method of claim 1, wherein the mobile device is in the form factor of a transaction card.

6. The method of claim 1, wherein the mobile device is a mobile phone.

7. The method of claim 1, wherein the host device is a tablet computer.

8. The method of claim 1, wherein the host device is a mobile phone.

9. A computer-implemented method comprising:
displaying, on a host device, a document to a user, the document including at least one data field receptive to data input;
receiving, by the host device from a mobile device, a first component of user data associated with the user, the first component of the user data stored by the mobile device;
assembling, by the host computer system, the user data based on the first component and a second component of the user data; and
inserting, by the host computer, the assembled user data in the data field based on an authorization gesture performed by the user through one or more physical movements of the mobile device.

10. The method of claim 9, further comprising:
transmitting information associated with the document to a server system, the server system determining whether document is appropriate for automatically filling the data field.

11. The method of claim 9, wherein a server system splits the user data into a plurality of components including the first component, the second component, and a third component, the second component provided by the server system to host device for storage and the third component stored by the server system.

12. The method of claim 11, further comprising, based on the host device receiving the document including the data field:
receiving, by the host device, the first component from the mobile device;
receiving, by the host device, the third component from the server system; and
assembling, by the host device, the user data based on the first, second, and third components.

13. The method of claim 9, wherein a server system splits the user data into a plurality of components including the first component, the second component, a third component, and a fourth component, wherein:
the third component is provided by the server system to the host device for storage;
the fourth component is stored by the server system; and
the first and second components are provided by the server system to a storage device, the storage device forwarding the first component to the mobile device for storage via a limited-range wireless connection, the second component stored by the storage device.

14. The method of claim 13, further comprising, based on the host device receiving the document including the data field:
receiving, by the host device, the first and second components from the storage device, the first component received by the storage device from mobile device via the limited-range wireless connection;
receiving, by the host device, the third component from the server system; and
assembling, by the host device, the user data based on the first, second, third, and fourth components.

15. The method of claim 13, further comprising, based on the host device receiving the document including the data field:
receiving, by the host device, the first, second, and third components from the server system, the server system receiving the first and second components from the storage device;
assembling, by the host device, the user data based on the first, second, third, and fourth components.

16. The method of claim 13, wherein the limited-range wireless connection is a Bluetooth connection.

17. The method of claim 9, wherein the first component is received responsive to a determination identifying the data field in the document.

18. The method of claim 9, wherein the first component is received responsive to the performance of the authorization gesture.

19. The method of claim 9, wherein the authorization gesture is one or more of the following: one or more tap movements with the mobile device, a swiping movement with the mobile device, and a rotation of the mobile device.

20. A non-transitory computer readable storage medium having computer program instructions that configure one or more processors to perform operations comprising:
displaying, on a host device, a document to a user, the document including at least one data field receptive to data input;
receiving, by the host device from a mobile device, a first component of user data associated with the user, the first component of the user data stored by the mobile device;
assembling, by the host computer system, the user data based on the first component and a second component of the user data; and
inserting, by the host computer, the assembled user data in the data field based on an authorization gesture performed by the user through one or more physical movements of the mobile device.
